(19) United States
(12) Patent Application Publication
(10) Pub. No.: US 2012/0155472 A1
(43) Pub. Date: Jun. 21, 2012

(54) APPARATUS AND METHOD FOR CLASSIFYING PACKETS

(75) Inventors: Sun Mi JUN, Daejeon (KR); Sook Jin LEE, Daejeon (KR)

(73) Assignee: ELECTRONICS TELECOMMUNICATIONS RESEARCH INSTITUTE, Daejeon (KR)

(21) Appl. No.: 13/326,874

(22) Filed: Dec. 15, 2011

(30) Foreign Application Priority Data
Dec. 16, 2010 (KR) 10-2010-0129409
May 11, 2011 (KR) 10-2011-0044228

(51) Int. Cl. H04L 12/28

(52) U.S. Cl. 370/392

(57) ABSTRACT

An apparatus for classifying packets obtains a connection index of a service flow corresponding to a key field value of a tunnel header of a downlink packet received from a network through tunnel, and transmit the downlink packets with the connection index as a header.

### CROSS-REFERENCE TO RELATED APPLICATION

This application claims priority to and the benefit of Korean Patent Application No. 10-2010-0129409 and 10-2011-0044228 filed in the Korean Intellectual Property Office on Dec. 16, 2010 and May 11, 2011, the entire contents of which are incorporated herein by reference.

### BACKGROUND OF THE INVENTION

(a) Field of the Invention

The present invention relates to an apparatus and method for classifying packets. More particularly, the present invention relates to an apparatus and method for classifying downlink packets.

(b) Description of the Related Art

In a wireless communication system, a base station includes a packet classifier for classifying downlink packets that are transmitted from a network. The packet classifier classifies packets and maps each packet to a corresponding service connection.

A typical packet classifier uses a content-addressable memory (CAM) to classify packets. The CAM stores IP addresses, a port number, and a connection index mapped thereto. The IP addresses may include a source address and/or a destination address, and the connection index may be used in wireless communication. Due to the CAM, an amount of data to be stored for classifying packets is increased. Accordingly, a packet classifier needs to have a large memory. When a corresponding connection index is searched for, it is required to search all bits of IP addresses indicating a source address and a destination address as well as the port number. Accordingly, processing time for classifying packets increases.

### SUMMARY OF THE INVENTION

The present invention has been made in an effort to provide an apparatus and method for classifying a packet having advantages of shortening a processing time for classifying packets and reducing a memory space.

An exemplary embodiment of the present invention provides a method for classifying a downlink packet in an apparatus for classifying packets. The method may include receiving the downlink packet from a network, determining a connection index of a service flow corresponding to a value of a first field in a first header of the downlink packet, and transmitting the downlink packet with the detected connection index as a second header.

The receiving of the downlink packet may include receiving the downlink packet through a generic routing encapsulation (GRE) tunnel. The first header may include a GRE header.

The first field may include a key field.

Before determining a connection index, the method may further include generating the connection index to identify the service flow when the service flow is generated, obtaining a value of the first field, which is determined when a tunnel is generated for the service flow with the network, and mapping the connection index of the service flow with the value of the first field and storing the mapping result in a search table.

Another embodiment of the present invention provides a method for classifying downlink packets in an apparatus for classifying packets. The method may include mapping a connection index with a value of a first field of a tunnel header corresponding ,to a service flow to a network and storing the mapping result in a search table, detecting the value of the first field in a tunnel header of the downlink packet when a downlink packet is received from the network, searching for a connection index corresponding to the value of the first field in the search table, and transmitting the downlink packet with the connection index as a second header.

Still another embodiment of the present invention provides an apparatus for classifying downlink packets. The apparatus may include a search table, a search unit, and a packet processor. The search table may store a connection index corresponding to a service flow and a value of a first field of a tunnel header mapped to the connection index. The search unit may obtain a value of the first field of a tunnel header of a downlink packet when the downlink packet is received from the network through tunnel, and may search for a connection index corresponding to the obtained value of the first field in the search table. The packet processor may transmit the downlink packet with the connection index.

The apparatus may further include a table generator. The table generator may map the connection index corresponding to the service flow with the value of the first field and store the mapping result in the search table.

The apparatus may further include a connection index generator and a detector. The connection index generator may generate the connection index when the service flow is generated and transfer the generated connection index to the search table generator. The detector may detect the value of the first field corresponding to the service flow when the tunnel is set up and transfer the detected value of the first field to the search table generator.

The tunnel header may be a generic routing encapsulation (GRE) header. The first field may include a key field.

### BRIEF DESCRIPTION OF THE DRAWINGS

FIG. 1 illustrates a wireless communication system in accordance with an exemplary embodiment of the present invention.

FIG. 2 illustrates a GRE header in accordance with an exemplary embodiment of the present invention.

FIG. 3 illustrates a method for generating a search table in an apparatus for classifying packets in accordance with an exemplary embodiment of the present invention.

FIG. 4 illustrates a method for classifying downlink packets in accordance with an exemplary embodiment of the present invention.

FIG. 5 illustrates an apparatus for classifying packets in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

In the specification, a terminal may be referred to as a mobile station (MS), a mobile terminal (MT), a subscriber station (SS), a portable subscriber station (PSS), user equipment (UE), and an access terminal (AT). The terminal may include entire or partial functions of the mobile station (MS), the mobile terminal (MT), the subscriber station (SS), the portable subscriber station (PSS), the user equipment (UE), and the access terminal (AT).

In the specification, a base station (BS) may be referred to as an access point (AP), a radio access station (RAS), a Node B, an evolved NodeB (eNodeB), a base transceiver station (BTS), or a mobile multihop relay (MMR)-BS. The base station may include entire or partial of functions of the access point (AP), the radio access station (RAS), the Node B, the evolved NodeB (eNodeB), the base transceiver station (BTS), or the mobile multihop relay (MMR)-BS.

Hereinafter, a method and apparatus for classifying packets in accordance with an exemplary embodiment of the present invention will be described with reference to the accompanying drawings.

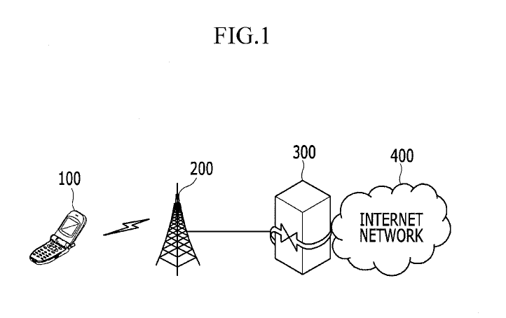

FIG. 1 illustrates a wireless communication system in accordance with an exemplary embodiment of the present invention.

Referring to FIG. 1, the wireless communication system may include a terminal 100, a base station 200, and a gateway 300.

The terminal 100 may be connected with the base station 200 through a wireless link. The terminal 100 may access an Internet network 400 through the base station 200.

The base station 200 may provide wireless connection to the Internet network 400 through the gateway 300.

As a coupling point of the Internet network 400, the gateway 300 may control the base station 200 and manage connection to the Internet network 400.

The base station 200 and the gateway 300 may transmit and/or receive packets through a generic routing encapsulation (GRE) tunnel. That is, the base station 200 and gateway 300 add a GRE header to a corresponding packet and transmit and/or receive the packet through a predetermined GRE tunnel between the base station 200 and the gateway 300.

The base station 200 may receive downlink packets, transmitted from the Internet network 400, through the gateway 300. The base station 200 may classify the received downlink packets and transmit the classified downlink packets to the terminal 100.

The base station 200 may include an apparatus for classifying packets. The apparatus for classifying packets may classify downlink packets and transmit the classified packets to the terminal 100. The apparatus for classifying downlink packets may use one field in a GRE header of a downlink packet. Furthermore, the apparatus for classifying packets may generate a search table for classifying the downlink packets.

The base station 200 may receive an uplink packet from the terminal 100, classify the uplink packets, and transmit the classified packets to the network.

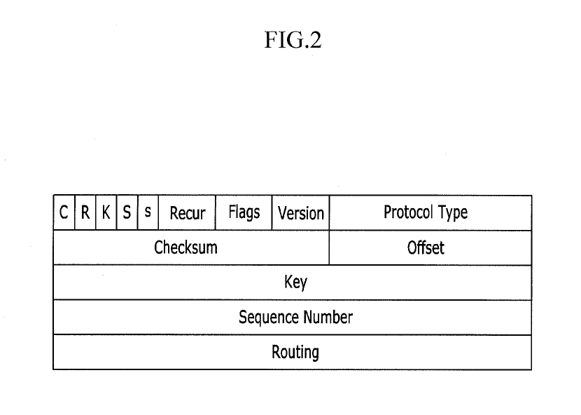

FIG. 2 illustrates a GRE header in accordance with an exemplary embodiment.

Referring to FIG. 2, the GRE header may include bit fields (C, R, K, S, s, Recur), a flag field (Flags), a version field (Version), a protocol type field (Protocol Type), a check sum field (Checksum), an offset field (Offset), a key field (Key), a sequence number field (Sequence Number), and a routing field (Routing).

The C-bit field (C) may include bit information corresponding to a check sum field. When bits of the C-bit field (C) are set up as 1, it indicates that information in the check sum field is valid.

The R-bit field (R) may include bit information corresponding to the offset and routing fields. When bits of the R-bit field (R) are set up as 1, information included in the offset field and the routing field is valid.

The K-bit field (K) may include bit information corresponding to the key field. When bits of the K-bit field (K) are set up as 1, the K-bit field (K) may indicate that information included in the key field is valid.

The S-bit field (S) may include information corresponding to the sequence number field. When bits of the S-bit field (S) are set up as 1, the S-bit field (S) may indicate that information included in the key field is valid.

Bits of the s-bit field (s) may be set up as 1 only if all routing information is configured as strict source routing.

The R-bit field (R) may indicate times of allowing encapsulation.

The version field may denote a version of a protocol.

The protocol type field may indicate a protocol type of a payload packet. Typically, the protocol type field may store an Ethernet protocol type.

The offset field may be marked when the R-bit field (R) or the C-bit field (C) is set up as 1. The offset field may include valid information only when the R-bit field (R) or the C-bit field (C) is set up as 1.

The checksum field may be marked when the R-bit field (R) or the C-bit field (C) is set up as 1. When the R-bit field (R) or the C-bit field (C) is set up as 1, the checksum field may include valid information.

The key field may store a key value used for a receiving node to authenticate a source of a respective packet. The key field may exist when the K-bit field (K) is set up as 1.

The sequence number field may be optional. The sequence number field may include information that can be used to accurately arrange packets received at a destination node.

The routing field may be optional. The routing field may include information used for routing. The routing field may exist when the R-bit field (R) is set up as 1.

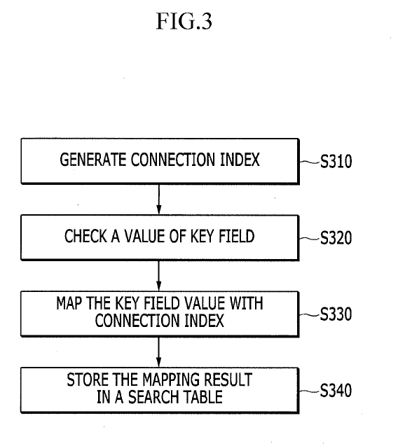

FIG. 3 illustrates a method for generating a search table in an apparatus for classifying packets in accordance with an exemplary embodiment of the present invention.

Referring to FIG. 3, at step S310, the apparatus for classifying packets may generate a unique connection index whenever a service flow is generated. With the connection index, each service flow may be identified. The base station 200 and the terminal 100 may transmit and receive packets through the connection index.

After generating the service flow, the base station 200 and the gateway 300 may perform a process for setting up a GRE tunnel. In the process, a key field value in a unique GRE header may be determined for each service flow.

The apparatus for classifying packets may create the search table by performing the following processes. The apparatus may detect a key field value in a GRE header corresponding to each service flow at step S320, map the key field value of the GRE header and the connection index at step S330, and insert and store the mapping result as a record of the search table at step S340.

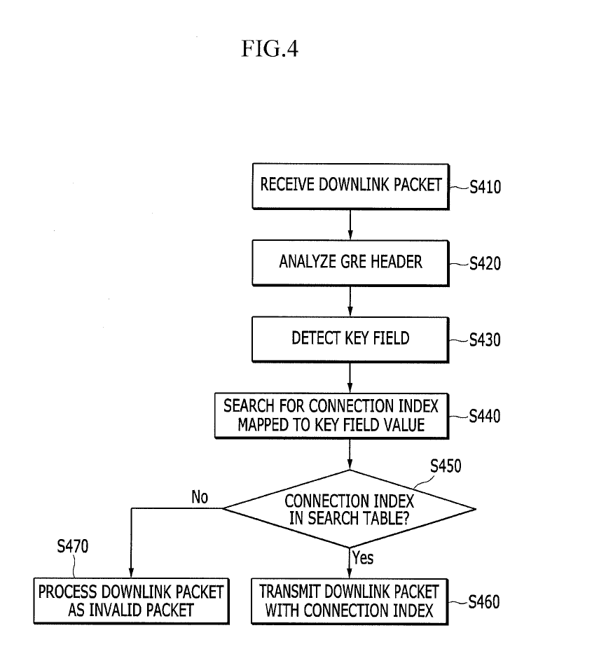

FIG. 4 illustrates a method for classifying downlink packets in an apparatus for classifying packets in accordance with an exemplary embodiment of the present invention.

Referring to FIG. 4, the apparatus for classifying packets may receive downlink packets from the Internet network 400 through the gateway 300 at step S410, and obtain a key field by analyzing the GRE header of the received downlink packet at steps S420 and S430.

The apparatus for classifying packets may search for a connection index mapped to a value of the detected key field in the search table at step S440.

When a respective connection index mapped to the key field value is included in the search table at step S450, the apparatus for classifying packets may create a service data unit (SDU) by interpreting the GRE header of the downlink packet, create a new header with the connection index, and transmit the downlink packet to the terminal 100 at step S460.

On the contrary, when the search table does not include a connection index mapped to the detected key field value at step S450, the apparatus for classifying packets may process a corresponding downlink packet as an invalid packet S470.

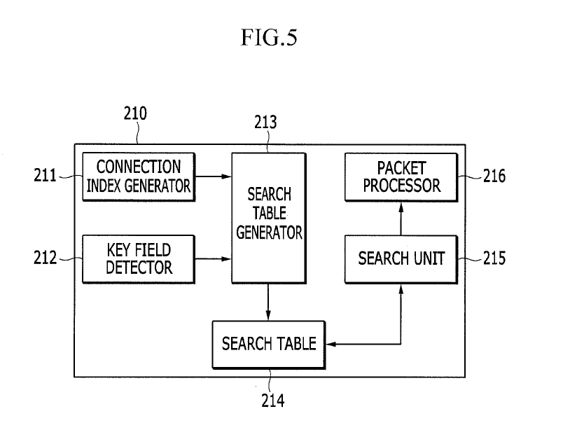

FIG. 5 illustrates an apparatus for classifying packets in accordance with an exemplary embodiment of the present invention.

Referring to FIG. 5, the apparatus 210 for classifying packet may include a connection index generator 211, a key field detector 212, a search table generator 213, a search table 214, a search unit 215, and a packet processor 216.

The connection index generator 211 may generate a connection index of a service flow whenever a service flow is generated in a wireless communication system, and transmit the connection index of each service flow to the search table generator 213.

The key field detector 212 may detect a key field value of a GRE header corresponding to each service flow between the base station 200 and the gateway 300, and transmit the detected key field value to the search table generator 213. The key field value of the GRE header may be determined when a GRE tunnel is set up for each service flow.

The search table generator 213 may receive the connection index of each service flow from the connection index generator 211 and receive the key field value from the key field detector 212, and map the received key field value to the received connection index and store the mapping result in the search table 214.

The search table 214 may store a connection index of each service flow, a corresponding key field value, and a mapping relation thereof.

The search unit 215 may receive a downlink packet from the gateway 300 through the GRE tunnel, detect a key field by analyzing a GRE header of the downlink packet, and search for a connection index mapped to the detected key field value in the search table 214.

The packet processor 216 may transmit a downlink packet with a connection index mapped to the detected key field value. The packet processor 216 may process the downlink packet as an invalid packet when a connection index mapped to the detected key field value is not included in the search table 214.

According to an exemplary embodiment of the present invention, downlink packets are classified using one field of a GRE header for connection to a network. Accordingly, processing time for downlink packets may be shortened, and a storage space may be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for classifying downlink packets in an apparatus for classifying packets, the method comprising:
receiving a downlink packet from a network;
determining a connection index of a service flow corresponding to a value of a first field in a first header of the downlink packet; and
transmitting the downlink packet with the detected connection index as a second header.

2. The method of claim 1, wherein the receiving the downlink packet includes
receiving the downlink packet through a generic routing encapsulation (GRE) tunnel,
wherein the first header includes a GRE header.

3. The method of claim 2, wherein the first field includes a key field.

4. The method of claim 1, before the determining a connection index, further comprising:
generating the connection index to identify the service flow when the service flow is generated;
obtaining a value of the first field, which is determined when a tunnel is generated for the service flow with the network; and
mapping the connection index of the service flow with the value of the first field and storing the mapping result in a search table.

5. The method of claim 4, wherein the determining a connection index includes searching for a connection index corresponding to the value of the first field in the search table.

6. The method of claim 4, wherein the determining a connection index includes processing the downlink packet as an invalid packet when the search table does not include a connection index corresponding to the value of the first field.

7. A method for classifying downlink packets in an apparatus for classifying packets, the method comprising:
mapping a connection index with a value of a first field of a tunnel header corresponding to a service flow to a network and storing the mapping result in a search table;
detecting the value of the first field in a tunnel header of the downlink packet when a downlink packet is received from the network;
searching for a connection index corresponding to the value of the first field in the search table; and
transmitting the downlink packet with the connection index as a second header.

8. The method of claim 7, wherein the tunnel header is a generic routing encapsulation (GRE) header.

9. The method of claim 8, wherein the first field includes a key field, and the storing the mapping result includes obtaining the value of the first field while setting up tunnel to the network.

10. An apparatus for classifying downlink packet, the apparatus comprising:
a search table configured to store a connection index corresponding to a service flow and a value of a first field of a tunnel header mapped to the connection index;
a search unit configured to obtain the value of the first field of a tunnel header of a downlink packet when the downlink packet is received from the network through tunnel, and search for a connection index corresponding to the obtained value of the first field in the search table; and
a packet processor configured to transmit the downlink packet with the connection index.

11. The apparatus of claim 10, further comprising
a table generator configured to map the connection index corresponding to the service flow with the value of the first field and store the mapping result in the search table.

12. The apparatus of claim 11, further comprising:
a connection index generator configured to generate the connection index when the service flow is generated and transfer the generated connection index to the search table generator; and
a detector configured to detect the value of the first field corresponding to the service flow when the tunnel is set up and transfer the detected value of the first field to the search table generator.

13. The apparatus of claim 10, wherein the tunnel header is a generic routing encapsulation (GRE) header.

14. The apparatus of claim 13, wherein the first field includes a key field.
